(19) United States
(12) Patent Application Publication
(10) Pub. No.: US 2026/0328200 A1
(43) Pub. Date: Oct. 22, 2026

(54) COMPRESSOR ASSEMBLY, COMPENSATION WEIGHT AND VEHICLE

(71) Applicant: ZF CV Systems Europe BV, Brussels (BE)

(72) Inventors: Morten Gehrke, Wennigsen (DE); Eugen Kloos, Viernheim (DE); Elmar Schillon, Algermissen (DE); Klaus Bredbeck, Landesbergen (DE); Uwe Stabenow, Laatzen (DE)

(21) Appl. No.: 19/696,165

(22) Filed: Jun. 2, 2026

Related U.S. Application Data
(63) Continuation of application No. PCT/EP2024/084099, filed on Nov. 29, 2024.

(30) Foreign Application Priority Data
Dec. 5, 2023 (DE) 10 2023 134 012.3

(51) Int. Cl. F04B 39/00; F04B 35/04

(52) U.S. Cl. CPC F04B 39/0027; F04B 35/04

(57) ABSTRACT

A compressor assembly is for a compressed air supply system of a vehicle. The compressor assembly includes an electric motor having a motor shaft and a compressor, which can be driven by the electric motor via the motor shaft. A first compensation weight for compensating unbalances is arranged on the motor shaft. The first compensation weight has an inner eccentric compensation mass portion and an outer centric inertial mass portion. A compensation weight is for a compressor assembly of a compressed air supply system. A vehicle, in particular a passenger car or commercial vehicle, includes a compressed air supply system and a compressor assembly.

### CROSS-REFERENCE TO RELATED APPLICATIONS

This application is a continuation of international patent application PCT/EP2024/084099, filed Nov. 29, 2024, designating the United States and claiming priority of German patent application no. 10 2023 134 012.3, filed Dec. 5, 2023, and the entire content of both applications is incorporated herein by reference.

### TECHNICAL FIELD

The disclosure relates to a compressor assembly for a compressed air supply system of a vehicle. The disclosure further relates to a compensation weight for such a compressor assembly and to a vehicle, in particular a passenger car or commercial vehicle, including a compressed air supply system and a compressor assembly.

### BACKGROUND

DE 10 2021 207 103 A1 discloses a scroll-type machine for a vehicle air conditioning system, which has an electric drive having a drive shaft, a first and a second scroll as well as a first and a second balance weight. The first and second balance weights are axially offset from one another and are attached to the drive shaft for conjoint rotation therewith. The second balance weight has an inclined surface, which is configured to generate a fluid flow for cooling the electric drive.

U.S. Pat. No. 10,954,944 B2 describes a compressor having a housing, a compressor mechanism, a drive shaft, a drive assembly and a compensation weight assembly that is secured on the drive shaft. The compensation weight assembly has a main body, a compensation mass and a spacer.

DE 10 2017 009 842 A1 describes a compressor assembly for a compressed air supply system including an electric motor that has an external rotor. According to an embodiment, the external rotor can have a centrifugal mass weight.

### SUMMARY

According to the features of an embodiment, a compressor assembly for a compressed air supply system of a vehicle is proposed. The compressor assembly includes an electric motor having a motor shaft and a compressor, which can be driven by means of the electric motor via the motor shaft, wherein a first compensation weight for compensating unbalances is arranged on the motor shaft, and wherein the first compensation weight has an inner eccentric compensation mass portion and an outer centric inertial mass portion.

In other words, a compressor assembly with a first compensation weight is proposed, which has two different functional portions in terms of shape, arrangement and purpose. While the inner eccentric compensation mass portion is provided predominantly for compensating unbalances and effects rotational mass compensation, the outer centric inertial mass portion serves predominantly to provide a supplementary increase in the moment of inertia of the first compensation weight. By combining a compensation mass portion for compensating unbalances with an additional inertial mass portion for increasing the moment of inertia, it is possible to provide a compressor assembly which is distinguished by smoother running and reduced noise generation and is also associated with the advantage of reduced power consumption, especially given the background situation that the compressor may have a pulsating load torque.

Compressor assemblies for the operation of compressed air supply systems are fundamentally known. They are used to generate compressed air by compressing ambient air using a compressor and make it available via the compressed air supply system to compressed air consumers such as air suspension systems, braking systems or level control systems. Compressors are often based on a positive displacement principle, in which air is trapped in a volume and the pressure is increased by reducing the volume. For example, piston compressors and rotary compressors, also called screw compressors, use such a positive displacement principle. According to an embodiment, the compressor assembly can have a compressor configured as a piston compressor, for example.

The compressor is driven by an electric motor connected to the compressor via a motor shaft. A rotational movement of the motor shaft can be converted in the compressor into a displacer movement, for example a stroke movement of a piston of the piston compressor. In the rotational movement of the motor shaft, unbalances can occur, for example, on account of components coupled to the motor shaft, such as an eccentric pin, or on account of shaft bearings supporting the motor shaft and dynamic effects during the operation of the compressor assembly, which affect the smoothness of running and power consumption of the electric motor and can lead to increased noise generation. Such effects can be countered in principle by compensating the unbalances by means of a compensation weight, with which rotational mass compensation is achieved by means of targeted positioning of a mass element. If, according to the features described, a further functional portion in the form of an outer centric inertial mass portion is additionally arranged on the first compensation weight, a significantly greater reduction of the power consumption and noise levels due to the electric motor as well as significantly smoother running can be achieved.

The first compensation weight has an inner eccentric compensation mass portion and an outer centric inertial mass portion. The inner eccentric compensation mass portion can have a geometric center and/or center of gravity radially offset from the axis of rotation of the compensation weight. The axis of rotation of the compensation weight can correspond to the axis of rotation of the motor shaft. The inner eccentric compensation mass portion can have a distance between a circumferential surface of the compensation mass portion and the axis of rotation which varies over the circumference. The outer centric inertial mass portion can have a geometric center and/or center of gravity which are/is substantially in the region of the axis of rotation. The outer centric inertial mass portion can have a distance between a circumferential surface of the inertial mass portion and the axis of rotation which is substantially constant over the circumference. The outer centric inertial mass portion can have a larger radius than the inner eccentric compensation mass portion. An outer circumferential surface of the outer centric inertial mass portion can be further away from the axis of rotation of the motor shaft than an outer circumferential surface of the compensation mass portion. The outer centric inertial mass portion can enclose the inner eccentric compensation mass portion.

The first compensation weight can advantageously be configured as a monolithic compensation weight. The inner eccentric compensation mass portion and the outer centric inertial mass portion can thus merge integrally into one another. It is conceivable that an outer circumferential surface of the inner eccentric compensation mass portion merges into the outer centric inertial mass portion.

The first compensation weight can be produced from a material including sintered steel or cast steel, for example. While sintered steel, for example, has proven advantageous for the production of the first compensation weight on account of the small processing effort involved, a higher density of the first compensation weight can be achieved with a cast steel material.

According to an embodiment, the inertial mass portion can have a larger mass than the compensation mass portion. An increased mass in the outer inertial mass portion advantageously increases the moment of inertia of the first compensation weight. The moment of inertia of the compensation weight depends on its mass distribution in relation to the axis of rotation and rises with increasing mass at an increasing distance from the axis of rotation. For example, a larger mass of the inertial mass portion can mean that the mass of the inertial mass portion is at least 1.2 times, at least 1.5 times or at least 2 times the mass of the compensation mass portion. In a numerical example to promote understanding, it can be assumed, in the case of a compressor assembly of a passenger car for example, that with a compensation mass portion having a mass of about 60 to 70 g, with which a significant compensation of unbalances can already be achieved under appropriate boundary conditions, the addition of an inertial mass portion of about 130 to 240 g can lead to a significantly reduced power consumption of, for example, 5 percent to 10 percent less power consumption. For compressor assemblies on commercial vehicles, larger masses of the compensation mass portion of several kilograms can be provided, depending on the vehicle type.

According to an embodiment, the compensation mass portion can have an arc-shaped compensation mass element. For example, an arc-shaped compensation mass element can project radially from a hub of the first compensation weight and have an arc-shaped circumferential surface. The arc-shaped compensation mass element can form a circular disk segment, for example. With the arc-shaped compensation mass element, an eccentric shape of the compensation mass portion is obtained and its center of gravity is shifted eccentrically. An arc-shaped compensation mass element promotes uniform rotation and smooth running of the motor shaft on which the first compensation weight is arranged and can be combined in an advantageous way with an outer centric inertial mass portion. For example, an arc-shaped compensation mass element can advantageously be integrated into a ring structure of an outer centric inertial mass portion.

According to an embodiment, the inertial mass portion can have an annular inertial mass element. An annular inertial mass element has a favorable centric shape with a uniform mass distribution at a constant distance from the axis of rotation. It is thereby possible to achieve an increase in the moment of inertia with the inertial mass portion without further shifts of the center of gravity of the first compensation weight with respect to the axis of rotation of the motor shaft on which the first compensation weight is arranged. The smoothness of running of the motor shaft can be further increased with an annular inertial mass element. The annular inertial mass element can be provided in particular at an outer circumference of the first compensation weight. The annular inertial mass element can have a closed ring structure. The annular inertial mass element can have a circular outer contour. The inertial mass portion can have a disk-shaped basic shape. This can be encircled by the annular inertial mass element. The annular inertial mass element can be a solid outer ring having a defined wall thickness, which is, for example, at least half the size of a ring width of the inertial mass element. The ring width can be, for example, an extent of the annular inertial mass element in the radial direction starting from a hub of the compensation weight, and the wall thickness can be an extent perpendicular to it parallel to the motor shaft.

According to a further development of the embodiment described above, the annular inertial mass element can have a circumferential stepped collar. A stepped collar can be a stepped cross-sectional extension on the outer circumference of the annular inertial mass element. The stepped collar can have a closed ring contour, for example. The step formed by the stepped collar on the inertial mass element enables at least a part of the inertial mass portion to be offset axially with respect to the compensation mass portion. A circumferential stepped collar allows differentiated mass distribution of the first compensation weight in the axial direction along the motor shaft. In addition, a circumferential stepped collar forms a favorable possibility of providing a larger mass on the inertial mass element and of arranging this as far out as possible on the inertial mass element, thus efficiently increasing the moment of inertia. The stepped collar can face a rotor of the electric motor, for example. This enables the inertial mass portion to be oriented closer to the rotor as a functional portion for increasing the moment of inertia, while the compensation mass portion can be oriented closer to the compressor to compensate for unbalances.

According to an embodiment, the compensation mass portion of the first compensation weight can have a spoke structure. A spoke structure can be one or more material struts flanked by material recesses, which can extend radially from a hub of the first compensation weight to the inertial mass portion, for example, to an annular inertial mass element of the inertial mass portion. With a spoke structure, compensation of unbalances can be further assisted by the compensation mass portion. By virtue of the flanking material recesses, the spoke structure can be associated with a reduction in mass, which can contribute to rotational mass compensation. The spoke structure can, for example, be arranged opposite an arc-shaped compensation mass element. In addition, the compensation mass portion can be stabilized or stiffened by the spoke structure. A spoke structure can also reduce a total mass of the first compensation weight. In addition, a spoke structure allows greater flexibility in the installation of components of the compressor assembly. Thus, for example, the material recesses in the compensation weight enable the bearing outer ring of the shaft bearing-configured, for example, as a ball bearing—to be supported during installation. According to a simple embodiment, the spoke structure can include a single material strut or just a few material struts, for example, a maximum of three material struts in order to make the compensation weight as simple as possible and thus facilitate the production of the compensation weight.

According to an embodiment, the first compensation weight can be arranged between a rotor of the electric motor and a first shaft bearing of the motor shaft. The rotor can be arranged on the motor shaft for conjoint rotation therewith, and can be at least partially surrounded by an external stator of the electric motor, such that an internal rotor motor is formed. The rotor and stator of the electric motor are used to convert an electric driving force of the electric motor into a rotational movement of the motor shaft. The first shaft bearing can be a rolling bearing, for example, a ball bearing. If the first compensation weight is arranged between the rotor and the first shaft bearing, the first compensation weight can advantageously stabilize the first shaft bearing. The first shaft bearing of the motor shaft can be arranged on a side of the motor shaft facing the compressor. In this case, acceleration forces close to the compressor can be compensated by the first compensation weight. By virtue of the increase in the mass moment of inertia of the first compensation weight brought about by means of the inertial mass portion, increased smoothness of running and stabilization of the motor shaft are achieved.

According to an embodiment, the first compensation weight can have a mass moment of inertia between 1.5*10-4 kgm² and 4.0*10-4 kgm². In particular, the first compensation weight can have a mass moment of inertia between 2*10-4 kgm² and 3.5*10-4 kgm². Such a compensation weight has favorable dimensioning for compressor assemblies in passenger cars and has an advantageous effect on the power consumption and noise levels of the electric motor. For a compressor assembly of a commercial vehicle, a first compensation weight with a significantly higher mass moment of inertia can be provided accordingly.

According to an embodiment, the electric motor and the motor shaft can be arranged in a drive housing, and the outer contour of the inertial mass portion of the first compensation weight projects up to an inner surface of the drive housing. This allows utilization of the installation space to be optimized in favor of a high moment of inertia of the compensation weight. The drive housing can, for example, have a flat wall structure with an outside facing the environment and an inside facing the electric motor and the motor shaft, wherein a surface of the inside forms an inner surface. The term “project up to” can be understood, for example, to mean that the outer contour of the inertial mass portion of the first compensation weight and the inner surface of the drive housing are adjacent to one another with an intermediate gap between them, without direct contact. Such a gap can, for example, correspond to the wall thickness of the drive housing in this region or be a maximum of twice or a maximum of three times as large as the wall thickness of the drive housing in this region. If the inertial mass portion has an annular inertial mass element with a circumferential stepped collar, an outer contour of the stepped collar can project as the outermost contour of the inertial mass portion up to the inner surface, for example. An outermost contour of the inertial mass portion can be a contour at the greatest distance from the axis of rotation.

According to an embodiment, a second compensation weight with an eccentric compensation mass portion can be arranged on the motor shaft. This allows for more precise unbalance compensation. In addition, unbalance compensation can be used selectively in different regions of the motor shaft. The eccentric compensation mass portion of the second compensation weight can be configured in a manner geometrically comparable to the eccentric compensation mass portion of the first compensation weight. A center of gravity of the eccentric compensation mass portion of the second compensation weight can be offset relative to a center of gravity of the eccentric compensation mass portion of the first compensation weight in relation to the axis of rotation. For example, a respective eccentric structure of the compensation mass portions of the first and second compensation weights can be aligned at different angles of rotation to the axis of rotation. As a supplementary measure, the second compensation weight can optionally have an additional inertial mass portion, which can be centrically shaped, for example, and can frame the eccentric compensation mass portion. The first and second compensation weights can be arranged on the motor shaft for conjoint rotation therewith in a manner axially offset with respect to one another. The second compensation weight can be arranged between the rotor and a second shaft bearing of the motor shaft, for example. The second shaft bearing can be arranged on a side of the motor shaft facing away from the compressor, for example. The rotor can be arranged between a motor-shaft side facing the compressor and a motor-shaft side facing away from the compressor, for example. The second compensation weight can advantageously serve for stabilization of the second shaft bearing. The second shaft bearing can be a rolling bearing, for example, a ball bearing. The second compensation weight can be produced from a material including sintered steel or cast steel, for example.

According to an embodiment, the electric motor can be configured as a brushless DC motor. A brushless DC motor, also referred to as a BLDC motor, is associated with high efficiency and a long service life of the electric motor. Brushless DC motors run very consistently and their speed is infinitely adjustable in a precise manner. In particular, the brushless DC motor can have an internal rotor and accordingly can be configured as an internal-rotor motor. The brushless DC motor can be an electronically commutated DC motor. The increased smoothness of running of the motor shaft and the reduced power consumption of the electric motor by virtue of the proposed first compensation weight allow better use of the advantages of a brushless DC motor in terms of a constant and precisely adjustable speed and enable a further increase in the efficiency of the electric motor.

The disclosure also relates to a compensation weight for a compressor assembly of a compressed air supply system of a vehicle, wherein the compensation weight has an inner eccentric compensation mass portion and an outer centric inertial mass portion. In particular, the compensation weight can be configured in accordance with any one of the features of the first compensation weight of the compressor assembly described above. In particular, the compensation weight can be configured for use in a compressor assembly according to one of the above-described features. The advantages of combined rotational mass compensation with a supplementary increase in the moment of inertia by means of an additional functional portion are also achieved with the proposed compensation weight. The compensation weight can be advantageously used in a compressor assembly according to the above-described features and, in this case, can achieve smoother running and reduced noise generation and power consumption by the electric motor.

The disclosure also relates to a vehicle, in particular a passenger car or commercial vehicle, including a compressed air supply system and a compressor assembly, wherein the compressor assembly is configured in accordance with any one of the above-described features. Vehicles represent an advantageous area of application for the compressor assembly described. In the field of vehicle mobility, there are high demands on the drives present in the vehicle, for example with regard to their energy consumption, their noise levels and their smoothness of running in order to reduce maintenance costs. In this context, passenger cars can represent a particularly interesting area of application for the proposed compressor assembly and compressed air supply system owing to a desired high level of comfort with low noise levels and owing to the expected low energy consumption. In addition, increased added value can also be achieved for commercial vehicles with a high compressed air requirement and compressor assemblies configured for a correspondingly high performance. The reduced power consumption of the electric motor with the proposed compressor assembly allows the use of smaller electric motors in the vehicle, which is particularly advantageous in view of the usually high share of the weight and installation space of the compressor assembly in the vehicle. The compressed air supply system of the vehicle can be configured, for example, to supply compressed air consumers such as an air suspension system or a pneumatic braking system.

### BRIEF DESCRIPTION OF DRAWINGS

The invention will now be described with reference to the drawings wherein:

FIG. 1 shows a compressor assembly for a compressed air supply system according to a first embodiment in a sectioned side view;

FIG. 2A shows a subassembly of the compressor assembly shown in FIG. 1 in a perspective side view;

FIG. 2B shows the subassembly shown in FIG. 2A in a sectioned side view;

FIG. 3 shows a subassembly of a compressor assembly for a compressed air supply system according to a second embodiment in a perspective side view;

FIG. 4 shows a first compensation weight for a compressor assembly according to a first embodiment in a perspective side view;

FIG. 5 shows a first compensation weight for a compressor assembly according to a second embodiment in a perspective side view;

FIG. 6 shows a second compensation weight for a compressor assembly according to an embodiment in a perspective side view;

FIG. 7 shows a schematic diagram of a passenger car with a compressed air supply system and a compressor assembly in a side view; and,

FIG. 8 shows a schematic diagram of a commercial vehicle with a compressed air supply system and a compressor assembly in a side view

### DETAILED DESCRIPTION

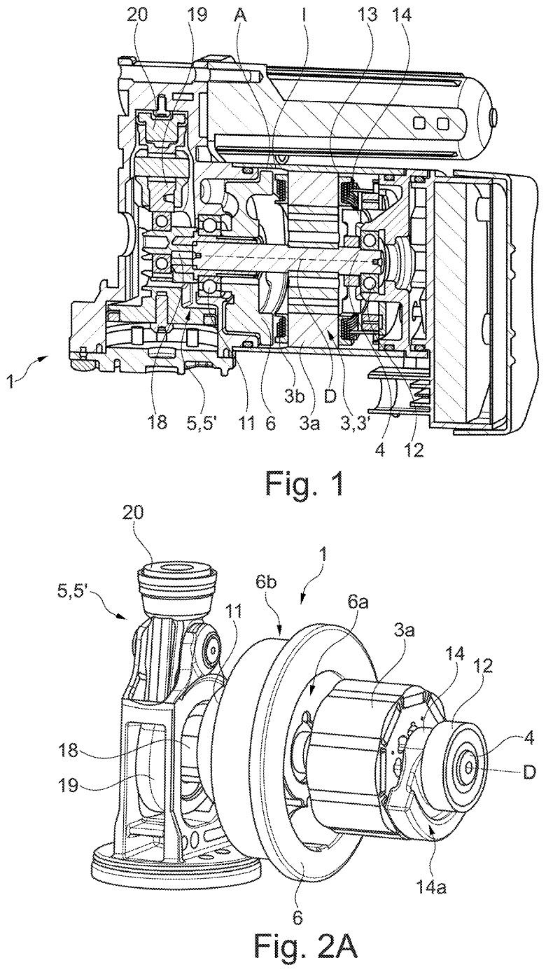

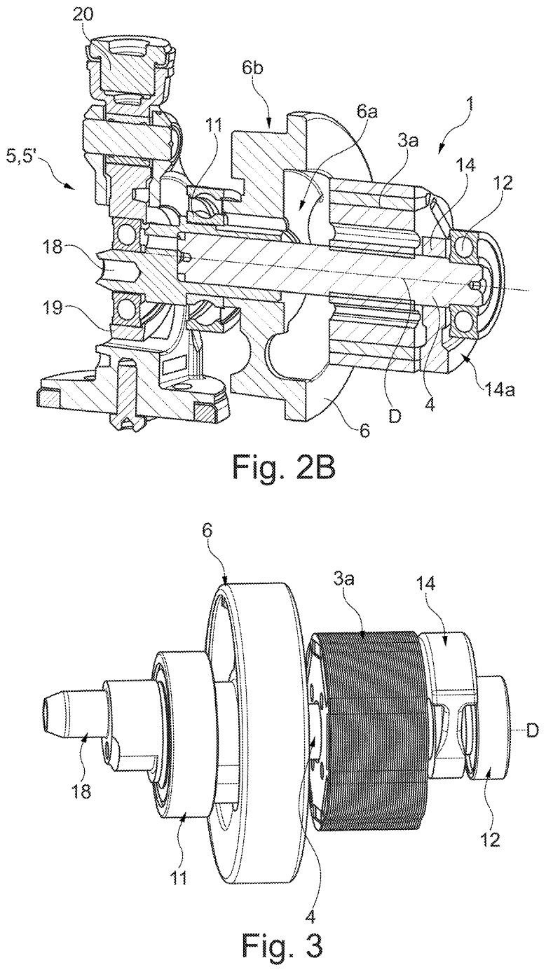

FIG. 1 shows a compressor assembly 1 for a compressed air supply system 2 according to a first embodiment in a sectioned side view, the supply system being indicated by way of example in FIG. 7. To give a better overview, FIGS. 2A and 2B show a subassembly of the compressor assembly 1 shown in FIG. 1, in a perspective view and a sectioned side view, respectively.

The compressor assembly 1 has an electric motor 3, which according to the embodiment shown is configured as a brushless DC motor 31. The electric motor 3 has a motor shaft 4, which can be set in rotational motion by a rotor 3a secured on the motor shaft 4. A compressor 5 can be driven via the motor shaft 4 by means of the electric motor 3. According to the first embodiment shown in FIGS. 1, 2A and 2B, the compressor 5 is configured as a piston compressor 5′. The piston compressor 5′ has a piston 20 as a displacer element, which, by virtue of a connecting rod 19 that can be driven by an eccentric pin 18 secured on the motor shaft 4, can carry out a stroke motion as a displacer movement.

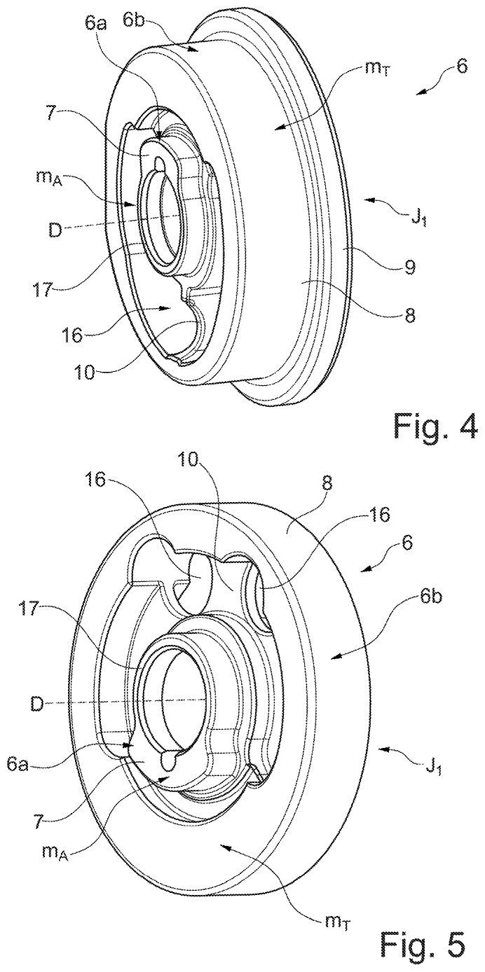

A first compensation weight 6 is arranged on the motor shaft 4 to compensate for unbalances. The first compensation weight 6 has an inner eccentric compensation mass portion 6a and an outer centric inertial mass portion 6b, as can also be seen from FIGS. 4 and 5 for example, which each show a first compensation weight 6 in isolation. The inner eccentric compensation mass portion 6a and the outer centric inertial mass portion 6b form two different functional portions of the first compensation weight 6, wherein the inner eccentric compensation mass portion 6a is provided for compensating unbalances and effects rotational mass compensation and wherein the outer centric inertial mass portion 6b increases the moment of inertia J₁ of the first compensation weight 6 in a complementary way. It is thereby possible to provide a compressor assembly 1 which runs more smoothly and develops less noise and in which the power consumption by the electric motor 3 is lower.

By virtue of its mass distribution, the inner eccentric compensation mass portion 6a has a center of gravity radially offset from an axis of rotation D of the first compensation weight 6. The axis of rotation D of the first compensation weight corresponds to the axis of rotation D of the motor shaft 4. By virtue of the eccentric shape of the inner eccentric compensation mass portion 6a, the distance between a circumferential surface of the compensation mass portion 6a and the axis of rotation D varies over the circumference.

By virtue of its mass distribution, the outer centric inertial mass portion 6b has a center of gravity which lies substantially in the region of the axis of rotation D. By virtue of the centric shape of the outer centric inertial mass portion 6b, the distance between a circumferential surface of the inertial mass portion 6b and the axis of rotation D remains substantially constant over the circumference. The outer centric inertial mass portion 6b frames the inner eccentric compensation mass portion 6a.

The first compensation weight 6 is of monolithic configuration, and the inner eccentric compensation mass portion 6a merges directly and integrally into the outer centric inertial mass portion 6b. Further details of the first compensation weight 6 will be explained in more detail below in conjunction with the explanation of FIGS. 4 and 5.

According to the first embodiment shown in FIGS. 1, 2A and 2B, the first compensation weight 6 is arranged between the rotor 3a of the electric motor 3 and a first shaft bearing 11—configured as a ball bearing—of the motor shaft 4. The rotor 3a is connected to the motor shaft 4 for conjoint rotation therewith and is partially surrounded by an external stator 3b of the electric motor 3, such that an internal rotor motor is formed. The first shaft bearing 11 is arranged between the compressor 5 and the first compensation weight 6. The electric motor 3 and the motor shaft 4 are arranged in a drive housing 13. An outer contour A of the inertial mass portion 6b, here of a stepped collar 9 of the inertial mass portion 6b, projects up to an inner surface I of the drive housing 13, thus optimizing installation space utilization in favor of a high moment of inertia J₁ of the first compensation weight 6.

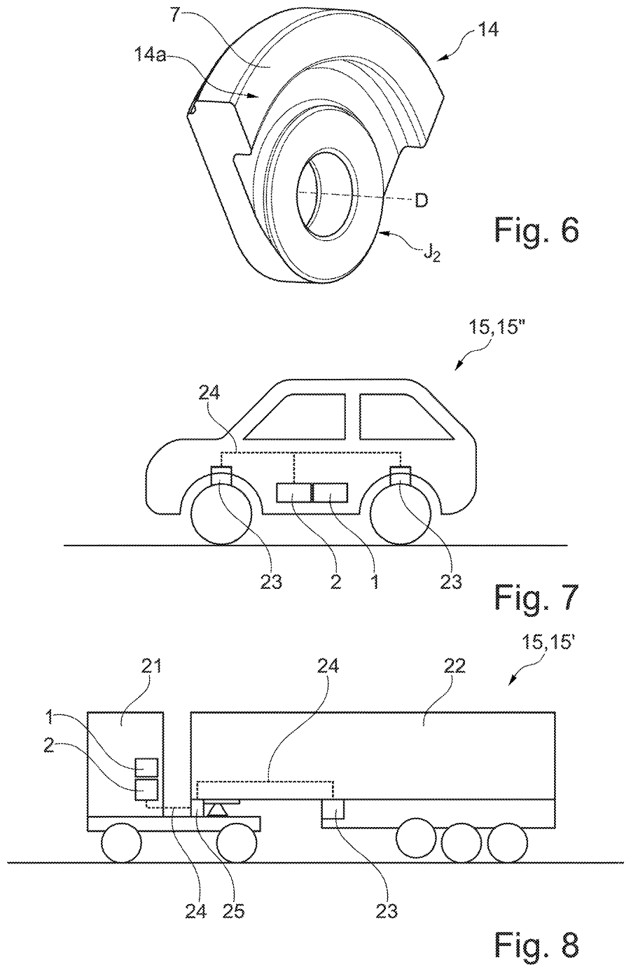

Arranged between the rotor 3a and a second shaft bearing 12 is a second compensation weight 14, which has an eccentric compensation mass portion 14a. As a result, there can be precise unbalance compensation in different areas of the motor shaft 4, and the second shaft bearing 12 can be stabilized by the second compensation weight 14. Further details of the second compensation weight 14 will be explained in more detail below in conjunction with the explanation of FIG. 6.

FIG. 3 shows a subassembly of a compressor assembly 1 for a compressed air supply system 2 according to a second embodiment in a perspective side view, where, for greater clarity, further subassemblies of the compressor assembly 1, for example a compressor housing and further compressor components, are omitted. The figure shows a motor shaft 4 of the compressor assembly 1, which is supported by means of a first shaft bearing 11 and a second shaft bearing 12 and on which a rotor 3a of an electric motor 3 is arranged. By means of an eccentric pin 18, a compressor 5 configured for example as a piston compressor 5′ can be operated as described above. Arranged between the rotor 3a and the first shaft bearing 11 is a first compensation weight 6, which, as per the first compensation weight 6 shown in FIG. 5, is configured according to a second embodiment and will be described in more detail below in conjunction with the explanation of FIG. 5. Arranged between the rotor 3a and the second shaft bearing 12 is a second compensation weight 14, which is configured as per the second compensation weight 14 shown in FIG. 6 and will be described in more detail below in conjunction with the explanation of FIG. 6. The first compensation weight 6 stabilizes the first shaft bearing 11, and the second compensation weight 14 stabilizes the second shaft bearing 12. Both compensation weights 6, 14 advantageously contribute to unbalance compensation and to an increase in the moment of inertia at the motor shaft 4.

FIGS. 4 and 5 each show a first compensation weight 6 in isolation, wherein FIG. 4 shows a first compensation weight 6 according to a first embodiment and FIG. 5 shows a first compensation weight 6 according to a second embodiment. The first compensation weight 6 shown in FIG. 4 is also shown in an installed state in FIGS. 1, 2A and 2B, and the first compensation weight 6 shown in FIG. 5 is also shown in an installed state in FIG. 3. As previously described, the first compensation weight 6 has an inner eccentric compensation mass portion 6a and an outer centric inertial mass portion 6b, which merge integrally into one another. In this case, the inertial mass portion 6b can have a mass m_{T} which is greater than a mass m_{A} of the compensation mass portion 6a in order to advantageously increase the moment of inertia J₁ of the first compensation weight 6. In both embodiments, the compensation mass portion 6a of the first compensation weight 6 has an arc-shaped compensation mass element 7, which projects radially from a hub 17 of the first compensation weight 6 and has an arc-shaped circumferential surface. In this case, the arc-shaped compensation mass element 7 forms a circular disk segment. With the arc-shaped compensation mass element 7, an eccentric shape of the compensation mass portion 6a is obtained, in which an outer contour of the compensation mass portion 6a is at a varying distance from the axis of rotation D of the first compensation weight 6 over its circumference. In both embodiments, the inertial mass portion 6b of the first compensation weight 6 has an annular inertial mass element 8. The annular inertial mass element 8 has a centric shape, in which an outer contour of the inertial mass portion 6b is at a substantially constant distance from the axis of rotation D of the first compensation weight 6 over its circumference. The annular inertial mass element 8 has a closed ring contour. The annular inertial mass element 8 contributes to the increase in the moment of inertia J₁ and makes the motor shaft 4 run more smoothly. The compensation mass portions 6a of the embodiments of the first compensation weight 6 which are shown in FIGS. 4 and 5 have a spoke structure 10, which is in the form of material struts flanked by material recesses 16. As illustrated, the spoke structure 10 can extend radially from the hub 17 to the annular inertial mass element 8 of the inertial mass portion 6b. By means of the spoke structure 10, the compensation of unbalances by the compensation mass portion 6a can be further enhanced and the total mass of the first compensation weight 6 can be reduced.

The first embodiment shown in FIG. 4 shows, as a departure from the second embodiment shown in FIG. 5, a first compensation weight 6 on which the annular inertial mass element 8 has a circumferential stepped collar 9. The stepped collar 9 forms a stepped cross-sectional extension on the outer circumference of the annular inertial mass element 8 and has a closed ring contour. As can be seen, for example, in FIG. 2A, the stepped collar 9 can face the rotor 3a of the electric motor 3 and, by increasing the moment of inertia J₁ close to the rotor and compensating unbalances close to the compressor, can contribute to a differentiated mass and function distribution.

FIG. 6 shows a second compensation weight 14 for a compressor assembly 1 according to an embodiment in a perspective side view. The second compensation weight 14 has an eccentric compensation mass portion 14a. The eccentric compensation mass portion 14a has an arc-shaped compensation mass element 7 on the outer circumference. By virtue of the eccentric shape, the distance between an outer contour of the compensation mass portion 14a and an axis of rotation D of the second compensation weight 14 varies over the circumference. The second compensation weight 14 has a moment of inertia J₂ which can optionally be increased by arranging an additional inertial mass portion on the second compensation weight 14.

FIG. 7 shows in a greatly simplified way, in a schematic diagram, a vehicle 15 configured as a passenger car 15″. The vehicle 15 has a compressed air supply system 2 for supplying compressed air to compressed air consumers 23 embodied as air spring bellows of an air suspension system via compressed air lines 24. For supplying the compressed air supply system 2 with compressed air, a compressor assembly 1 is provided in the vehicle 15, which can be configured in accordance with the features described above and can be configured to compress ambient air to give compressed air by means of a compressor 5 driven by an electric motor 3. As described, the compressor assembly 1 described can be used to achieve the advantages of smoother running and reduced noise generation and power consumption at the electric motor 3. The reduced power consumption of the electric motor 3 with the proposed compressor assembly 1 allows the use of smaller electric motors 3 in the vehicle.

FIG. 8 shows in a greatly simplified manner, in a schematic diagram, a vehicle 15 configured as a commercial vehicle 15′, which according to the embodiment shown has a towing vehicle 21 and a trailer vehicle 22. The vehicle 15 has a compressed air supply system 2 arranged in the towing vehicle 21 for supplying a compressed air consumer 23 located in the trailer vehicle 22 with compressed air via compressed air lines 24 and a compressed air connection 25 on the trailer vehicle 22. To supply the compressed air supply system 2 with compressed air, a compressor assembly 1 is provided in the towing vehicle 21, and this compressor assembly can be configured in accordance with the features described above and can be configured to compress ambient air to give compressed air by means of a compressor 5 driven by an electric motor 3. As described, the compressor assembly 1 described can be used to achieve the advantages of smoother running and reduced noise generation and power consumption at the electric motor 3. The reduced power consumption of the electric motor 3 with the proposed compressor assembly 1 allows the use of smaller electric motors 3 in the vehicle.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Compressor assembly
2 Compressed air supply system
3 Electric motor
3′ Brushless DC motor
3a Rotor
3b Stator
4 Motor shaft
5 Compressor
5′ Piston compressor
6 First compensation weight
6a Compensation mass portion of first compensation weight
6b Inertial mass portion
7 Compensation mass element
8 Inertial mass element
9 Stepped collar
10 Spoke structure
11 First shaft bearing
12 Second shaft bearing
13 Drive housing
14 Second compensation weight
14a Compensation mass portion of second compensation weight
15 Vehicle
15 Commercial vehicle
15″ Passenger car
16 Material recess
17 Hub
18 Eccentric pin
19 Connecting rod
20 Piston
21 Towing vehicle
22 Trailer vehicle
23 Compressed air consumer
24 Compressed air line
25 Compressed air connection
A Outer contour of inertial mass portion
D Axis of rotation
I Inner surface of drive housing
11 Moment of inertia of first compensation weight
12 Moment of inertia of second compensation weight
m_{A} Mass of compensation mass portion
m_{T} Mass of inertial mass portion

1. A compressor assembly for a compressed air supply system of a vehicle, the compressor assembly comprising:
an electric motor having a motor shaft;
a compressor configured to be driven by said electric motor via said motor shaft;
a first compensation weight for compensating unbalances arranged on said motor shaft; and,
said first compensation weight having an inner eccentric compensation mass portion and an outer centric inertial mass portion.

2. The compressor assembly of claim 1, wherein said outer centric inertial mass portion has a larger mass than said inner eccentric compensation mass portion.

3. The compressor assembly of claim 1, wherein said inner centric compensation mass portion has an arc-shaped compensation mass element.

4. The compressor assembly of claim 1, wherein said outer centric inertial mass portion has an annular inertial mass element.

5. The compressor assembly of claim 4, wherein said annular inertial mass element has a circumferential stepped collar.

6. The compressor assembly of claim 1, wherein said inner centric compensation mass portion of said first compensation weight has a spoke structure.

7. The compressor assembly of claim 1, wherein said first compensation weight is arranged between a rotor of said electric motor and a first shaft bearing of said motor shaft.

8. The compressor assembly of claim 1, wherein said first compensation weight has a mass moment of inertia between 1.5*10-4 kgm² and 4.0*10-4 kgm².

9. The compressor assembly of claim 1, wherein said electric motor and said motor shaft are arranged in a drive housing; and, an outer contour of said outer centric inertial mass portion of said first compensation weight projects up to an inner surface of said drive housing.

10. The compressor assembly of claim 1 further comprising a second compensation weight having an eccentric compensation mass portion arranged on said motor shaft.

11. The compressor assembly of claim 1, wherein said electric motor is configured as a brushless DC motor.

12. A compensation weight for a compressor assembly of a compressed air supply system of a vehicle, the compensation weight comprising an inner eccentric compensation mass portion and an outer centric inertial mass portion.

13. The compensation weight of claim 12, wherein said outer centric inertial mass portion has a larger mass than said inner eccentric compensation mass portion.

14. The compensation weight of claim 12, wherein said inner centric compensation mass portion has an arc-shaped compensation mass element.

15. The compensation weight of claim 12, wherein said outer centric inertial mass portion has an annular inertial mass element.

16. The compensation weight of claim 12, wherein said annular inertial mass element has a circumferential stepped collar.

17. The compensation weight of claim 12, wherein said inner centric compensation mass portion of said first compensation weight has a spoke structure.

18. The compensation weight of claim 12, wherein said first compensation weight has a mass moment of inertia between 1.5*10-4 kgm² and 4.0*10-4 kgm².

19. A vehicle comprising:
a compressed air supply system;
a compressor assembly including an electric motor having a motor shaft;
said compressor assembly further including a compressor configured to be driven by said electric motor via said motor shaft;
said compressor assembly further including a first compensation weight for compensating unbalances arranged on said motor shaft; and,
said first compensation weight having an inner eccentric compensation mass portion and an outer centric inertial mass portion.

20. The vehicle of claim 19, wherein the vehicle is a passenger car or a commercial vehicle.
